(19) United States
(12) Patent Application Publication
(10) Pub. No.: US 2008/0240869 A1
(43) Pub. Date: Oct. 2, 2008

(54) Reverse tipped router bit

(75) Inventor: Bobby Hall, N. Wilkesboro, NC (US)

Correspondence Address: WEGMAN, HESSLER & VANDERBURG, 6055 ROCKSIDE WOODS BOULEVARD, SUITE 200, CLEVELAND, OH, 44131, US

(73) Assignee: Zibra, LLC, Mooresville, NC (US)

(21) Appl. No.: 11/731,985

(22) Filed: Apr. 2, 2007

(51) Int. Cl. B26D 1/12

(52) U.S. Cl. 407/32

(57) ABSTRACT

A router bit with an elongate body having a shank end and a cutter element support head. The shank end projects outwardly from the body to facilitate mounting the router bit on a rotating machine, and the cutter element support head extends in the opposite direction from the shank end and has an axis of rotation (A) which is coaxial with the shank. The cutter element support head is formed with two flutes in a diametrically opposed relation, each flute having an outer surface and a cut-away inner surface with a groove being formed in the outer surface of the flute along the longitudinal length of the cutter element support head. An elongate cutter element is affixed in the longitudinal groove of each flute. The cutter elements are configured such that they form a hook angle (α) that is greater than or equal to 35 degrees.

### BACKGROUND OF THE INVENTION

1. Field of Invention

This invention relates to cutting tools, and more specifically to a reversed tipped router bit.

2. Description of Related Art

Router bits and/or cutting end mills such as the one shown in FIG. 1 used with power driven router machines designed to perform precision cutting on planar or curved surfaces of a workpiece are well known in the art. These router bits typically have removable cutting blades referred to as knives or cutter elements. These cutter elements are commonly, but not exclusively, made from various grades of carbide, tantung, or high speed steel ceramic and the like. The cutter elements are then brazed or soldered into seats formed in fluted portions of a shank that is connected to a motor spindle through a chuck and collar. For example, U.S. Pat. No. 3,803,950 issued to Wasser teaches a router bit with a carbide bit portion.

Router bits can be formed such that the cutter elements have various hook angles, and an appropriate router bit is selected based on its hook angle and the hardness, density and/or grain variation of the material to be cut. As higher hook angles produces a more aggressive cutting action, the desired hook angle of the router bit for a particular job varies according to the density or hardness of the material. For example, hook angles used in metal working are generally different from the hook angles used with woods, plastics and other nonferrous materials. For hard metals, a smaller or even negative hook angle is desirable. Generally, wood, plywood, acrylics (Plexiglas®), plastics, nonferrous metals and other similar materials have a broader range of possible hook angles that typically range from −5 degrees to 35 degrees. However, the maximum hook angle is typically limited by the geometry of the conventional router bit.

It would be desirable to provide an improved router bit capable of using a higher hook angle to produce a more aggressive cutting action in order to provide a faster feed rate without significant compromise of cut quality.

### SUMMARY OF THE INVENTION

One aspect of the invention is directed to a router bit with an elongate body having a shank end and a cutter element support head. The shank end projects outwardly from the body to facilitate mounting the router bit on a rotating machine, and the cutter element support head extends in the opposite direction from the shank end and has an axis of rotation (A) which is coaxial with the shank. The cutter element support head is formed with two flutes in a diametrically opposed relation, each flute having an outer surface and a cut-away inner surface with a groove being formed in the outer surface of the flute along the longitudinal length of the cutter element support head. An elongate cutter element is affixed in the longitudinal groove of each flute. Each cutter element has a leading edge face and a trailing face that come together at one side of the cutter element to define a cutting tip for cutting a workpiece when the router bit is rotated, and is positioned such that a base end of the leading edge face is positioned in the groove adjacent the flute and a base end of the trailing face forms a portion of the outer circumferential surface of the router bit. The cutter elements are configured such that they form a hook angle (α) that is greater than or equal to 35 degrees, wherein the hook angle (α) is the angle at which the tip of the cutter element attacks the surface of a workpiece as determined by the leading edge face relationship to the axis (A) of the router bit.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a sectional view of a prior art router bit;

FIG. 2 is a sectional view of a router bit according to an embodiment of the invention;

FIG. 3 is a side view of the router bit of FIG. 2;

FIG. 4 is a sectional view of the router bit of FIG. 2 with the cutter element removed;

FIG. 5 is an side view of the router bit of FIG. 4; and

FIG. 6 is an enlarged sectional view of the router bit of FIG. 2.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

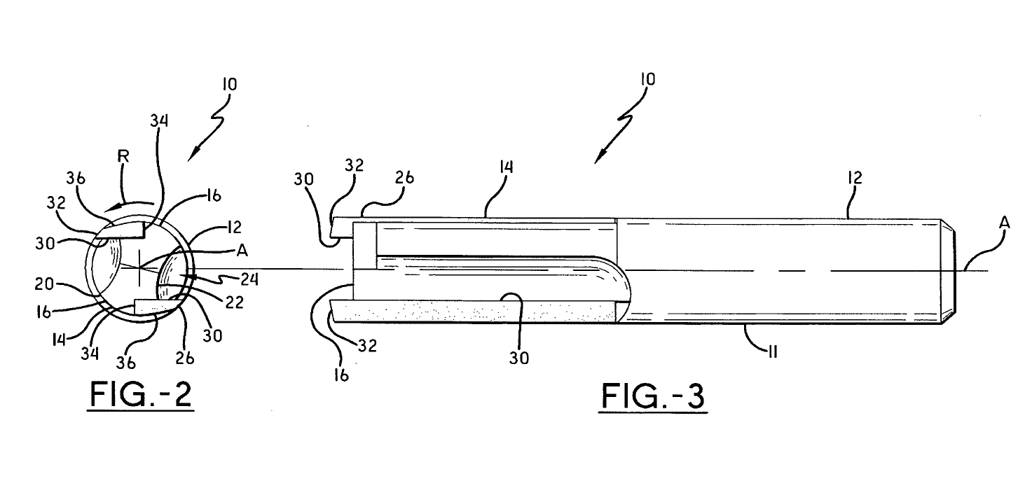

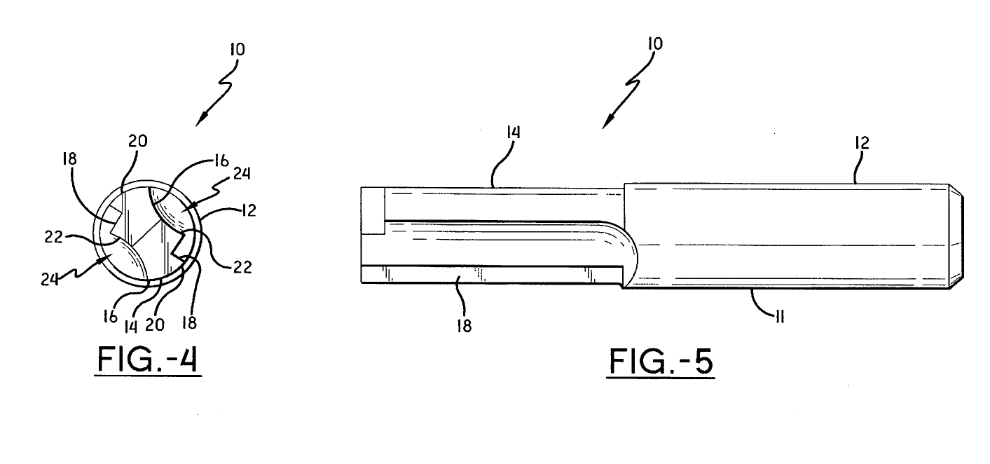

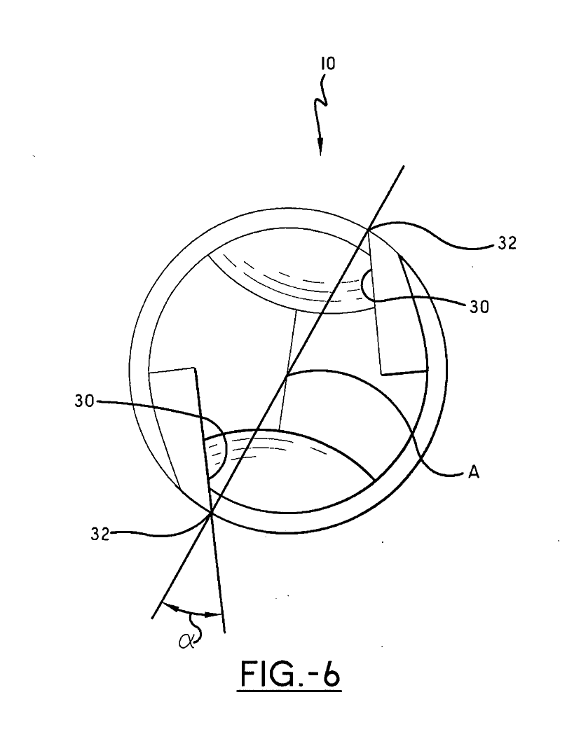

Referring now to FIGS. 2 and 3, a router bit 10 is illustrated that includes a generally elongate body 11 having a shank end 12 and a cutter element support head 14. The shank end 12 is generally circular in cross-section and projects outwardly from the body 11 to facilitate mounting the router bit 10 on a rotating machine (not shown) for cutting operations. The cutter element support head 14 extends in the opposite direction from the shank end 12 and has an axis of rotation (A) which is coaxial with the shank end 12. The illustrated cutter element support head 14 is formed with two flutes 16 in generally diametrically opposed relation. Each flute 16 has an outer surface 20 and a cut-away or receding inner surface 22 that forms a pocket 24. A longitudinal groove 18, as best seen in FIGS. 4 and 5, is formed in the outer surface 20 of each flute 16 along the longitudinal length of the cutter element support head 14. An elongate cutter element 26 is fixed in each of the longitudinal grooves 18. The pocket 24 is adapted to accumulate chips cut by the router bit 10 and direct the chips away from the cutter element 26. Although the illustrated router bit 10 has two flutes 16, it is conceived that the router bit may have a different number of flutes, such as three flutes.

As best seen in the sectional view of FIG. 2, in one embodiment each cutter element 26 is shaped such that it has a major axis that is generally parallel with a leading edge face 30 of the cutter element 26 and a shorter minor axis perpendicular to the major axis. One side of the cutter element 26 is defined by a cutting tip 32 for cutting the workpiece when the router bit 10 is rotated in the direction of the arrow (R) in FIG. 2. The opposing side of the cutter element 26 forms a base end 34 that is seated in the longitudinal groove 18 of the flute 16. A trailing face 36 of the cutter element 22 is opposed the leading face 30 and may be curved from the tip 32 to the base end 34. These cutter elements 26 are of a durable material, preferably tungsten carbide since this material is easily preformed and is economical. Although the hardened cutter elements 26 are contemplated as being of tungsten carbide, other hardened materials may be selected from the many which are conventionally used without departing from the scope of the invention. Each of these cutter elements 26 is contemplated as being substantially identical. Each cutter element 26 is preferably preformed before being brazed in the grooves 18 formed in the fluted portion of the router bit 10. In the illustrated embodiment, the cutter elements 26 when brazed in position in the flutes 16 of the router bit 10 have their leading edge faces 30 lying in planes generally parallel to each other.

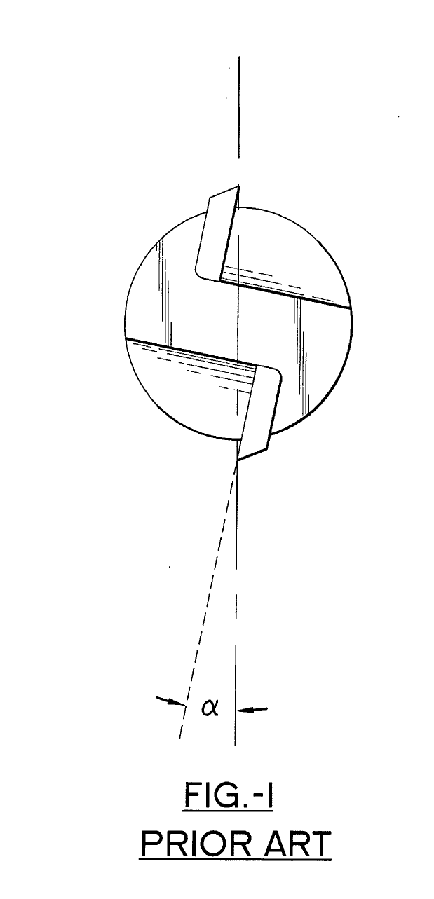

According to the invention, the cutter element 26 is received in longitudinal groove 18 of the flute 16 in a reverse manner from the prior art of FIG. 1 such that the base end 34 of the leading edge face 30 is positioned adjacent the flute 16 and the base end of the trailing face 36 forms a portion of the outer circumferential surface 20 of the router bit 10. Turning now to FIG. 6, in this orientation, the cutter elements 26 in the router bit 10 can form a larger hook angle (α) than conventionally achievable. The hook angle (α) is the angle at which the tip 32 of the cutter element 26 attacks the surface the workpiece as determined by the leading edge face 30 relationship to the central axis (A) of the router bit 10. In a cross-section perpendicular to the axis (A), the hook angle (α) is the angle between a line intersecting the router bit axis (A) and the cutting tip 32 of the cutter element 26 and a line along the leading edge face 30 of the cutter element 26. In FIG. 6, the hook angle (α) is roughly 45 degrees. Desirably, the hook angle (α) is between about 15 and 60 degrees, more desirably between about 35 and 55 degrees, and even more desirably between about 40 and 50 degrees.

As seen in FIGS. 3 and 5, the extent and length of the flutes 16 may be about 1½ inches in length thus providing a router bit 10 having a substantial leading edge face 30 to which the workpiece may be presented. However, this length is merely a matter of selection. The diameter and size of the router bit 10 as above-described is also a matter of selection since the bits are conventionally made from one-quarter inch diameter and larger. The router bits generally have regular lengths of flutes 16, such as 1 inch, 1½ inches, 2 inches, etc. It is contemplated that the cutter elements 26 be mass produced in the shown cross-section and made in desired like lengths. It is further contemplated that the same cutter element 26 as to cross-section be used whether the router bit be one-quarter inch in diameter, three-eights inch in diameter, one-half, three-quarter, seven-eights, 1 inch or other diameters. The cutter element 26 having been previously established, it is only necessary that the grooves 18 be cut in a previously formed router bit body 11 to accommodate these hardened cutter elements 26.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. A router bit comprising an elongate body having a shank end and a cutter element support head, wherein the shank end projects outwardly from the body to facilitate mounting the router bit on a rotating machine, and wherein the cutter element support head extends in the opposite direction from the shank end and has an axis of rotation (A) which is coaxial with the shank end, the cutter element support head being formed with two flutes in a diametrically opposed relation, each flute having an outer surface and a cut-away inner surface with a groove being formed in the outer surface of the flute along the longitudinal length of the cutter element support head, wherein an elongate cutter element is affixed in the longitudinal groove of each flute, each cutter element having a leading edge face and a trailing face that come together at one side of the cutter element to define a cutting tip for cutting a workpiece when the router bit is rotated, and is positioned such that a base end of the leading edge face is positioned in the groove adjacent the flute and a base end of the trailing face forms a portion of the outer circumferential surface of the router bit and the cutter elements are configured such that they form a hook angle (α) that is greater than or equal to 35 degrees, wherein the hook angle (α) is the angle at which the tip of the cutter element attacks the surface of a workpiece as determined by the leading edge face relationship to the axis (A) of the router bit.

2. The router bit of claim 1 wherein each cutter element is shaped such that it has a major axis that is generally parallel with a leading edge face of the cutter element and a shorter minor axis perpendicular to the major axis.

3. The router bit of claim 2 wherein a side of the cutter element opposing the tip forms a base end that is seated in the longitudinal groove of the flute.

4. The router bit of claim 3 wherein the cutter elements have their leading edge faces parallel to each other.

5. The router bit of claim 1 wherein the cutter elements are of tungsten carbide.

6. The router bit of claim 1 wherein the cutter elements are brazed in position in the flutes.

7. The router bit of claim 1 wherein the hook angle (α) is the angle between a line intersecting the axis (A) and the cutting tip of the cutter element and a line along the leading edge face of the cutter element.

8. The router bit of claim 7 wherein the hook angle (α) is between about 40 and 50 degrees.
